(19) United States
(12) Patent Application Publication
(10) Pub. No.: US 2025/0356540 A1
(43) Pub. Date: Nov. 20, 2025

(54) STYLE TRANSFER USING GENERATIVE DIFFUSION FEATURES

(71) Applicant: DISNEY ENTERPRISES, INC., Burbank, CA (US)

(72) Inventors: Abdelaziz DJELOUAH, Zürich (CH); Dan Sebastian RUTA, Zürich (CH); Raphael Francois ORTIZ, Dübendorf (CH); Christopher Richard SCHROERS, Uster (CH)

(21) Appl. No.: 19/205,687

(22) Filed: May 12, 2025

Related U.S. Application Data
(60) Provisional application No. 63/649,278, filed on May 17, 2024.

(51) Int. Cl. G06T 11/00; G06T 5/50; G06T 5/60; G06T 5/70; G06V 10/40; G06V 10/762; G06V 10/77; G06V 10/774; G06V 10/82

(52) U.S. Cl. CPC G06T 11/00; G06T 5/50; G06T 5/60; G06T 5/70; G06V 10/40; G06V 10/762; G06V 10/7715; G06V 10/774; G06V 10/82; G06T 2207/20081; G06T 2207/20084; G06T 2207/20216

(57) ABSTRACT

The present invention sets forth techniques for performing style transfer from multiple supplied style images to a supplied content image to generate novel images that include style elements from the multiple supplied style images and content elements from the supplied content image. The techniques include guiding one or more self-attention and cross-attention layers included in a machine learning model based on the multiple supplied style images, such that content elements and style elements included in the style images are not entangled when generating the novel images. The techniques also distill a small subset of representative attention map values from multiple style images, improving performance while reducing computational costs compared to processing all attention map values from the multiple style images.

### CROSS-REFERENCE TO RELATED APPLICATIONS

This application claims priority benefit to U.S. Provisional application titled “STYLE TRANSFER USING GENERATIVE DIFFUSION FEATURES,” filed on May 17, 2024, and having Ser. No. 63/649,278. This related application is also hereby incorporated by reference in its entirety.

### BACKGROUND

### Field of the Various Embodiments

Embodiments of the present disclosure relate generally to computer vision and image processing and, more specifically, to techniques for performing style transfer using generative diffusion features, including all aspects of the related hardware, software, graphical user interfaces, and algorithms associated with implementing the contemplated systems, techniques, functions, and operations set forth herein,

### Description of the Related Art

In the fields of machine learning and computer vision, domain adaptation or style transfer refers to the generation of novel images that exhibit content features inherited from a supplied content image and stylistic features inherited from one or more supplied style images. For example, a supplied content image may include a photograph of a building against a background, and one or more supplied style images may collectively exhibit one or more style elements, such as an impressionist or cubist artistic style, brush strokes, drawn lines, and/or colors. In this example, style transfer techniques may generate one or more novel images depicting the building, background, and/or other content elements included in the supplied content image, such that the generated image(s) also exhibit one or more style elements included in the supplied style images. Content elements may include features such as objects, lines, edges, outlines, or surfaces. Style elements may further include, but are not limited to, textures, patterns, or lighting characteristics.

Existing style transfer techniques may be limited to considering a single style image when performing style transfer, and may generate poor style transfer results. For example, existing techniques may fail to adequately transfer style elements into generated novel images. Existing techniques may also entangle content and style in undesired ways, such that content elements included in a style image are inadvertently transferred to the generated novel image. Other existing techniques may consider multiple style images in an attempt to improve visual performance, but are not computationally performant to consider more than a few style images because features, such as attention maps, extracted from even a single style image may exceed 5-7 GB (gigabytes) in size.

As the foregoing illustrates, what is needed in the art are more effective techniques for performing style transfer.

### SUMMARY

One embodiment of the present invention sets forth a technique for performing style transfer from one or more style images to a content image. The technique includes receiving a content image including one or more content elements, and multiple style images each including one or more style elements. The technique also includes generating an average embedding and an average style image based on the multiple style images, and generating, via a clustering technique, a representative set of attention map keys and values associated with the multiple style images. The technique further includes and generating, via a trained machine learning model and based at least on the average embedding, the average style image, and the representative set of attention map keys and values, a stylized output image including at least one of the one or more content elements and at least one of the one or more style elements.

One technical advantage of the disclosed techniques relative to the prior art is that the disclosed techniques leverage multiple supplied style images to improve visual performance in generating novel images. Specifically, the disclosed techniques may consider a large number of style images by distilling a small representative set of features from multiple style images, reducing computing requirements. The disclosed techniques also avoid content/style entanglement when performing style transfer. These technical advantages provide one or more improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present invention.

FIG. 2 is a more detailed illustration of the style transfer engine of FIG. 1, according to some embodiments.

FIG. 3 is a flow diagram of method steps for performing style transfer, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

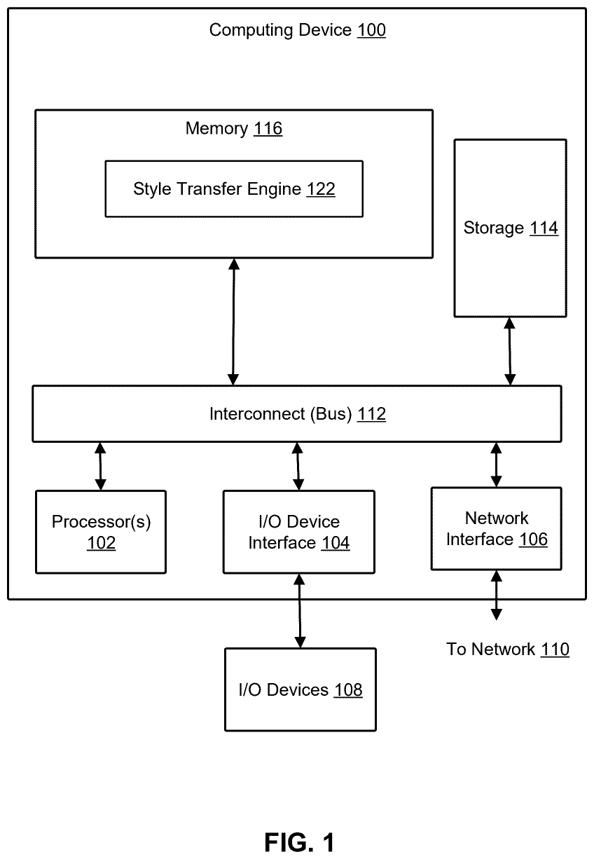

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run style transfer engine 122 that resides in a memory 116.

It is noted that the computing device described herein is illustrative and that any other technically feasible configurations fall within the scope of the present disclosure. For example, multiple instances of style transfer engine 122 could execute on a set of nodes in a distributed and/or cloud computing system to implement the functionality of computing device 100. In another example, style transfer engine 122 could execute on various sets of hardware, types of devices, or environments to adapt style transfer engine 122 to different use cases or applications. In a third example, style transfer engine 122 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Style transfer engine 122 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including style transfer engine 122.

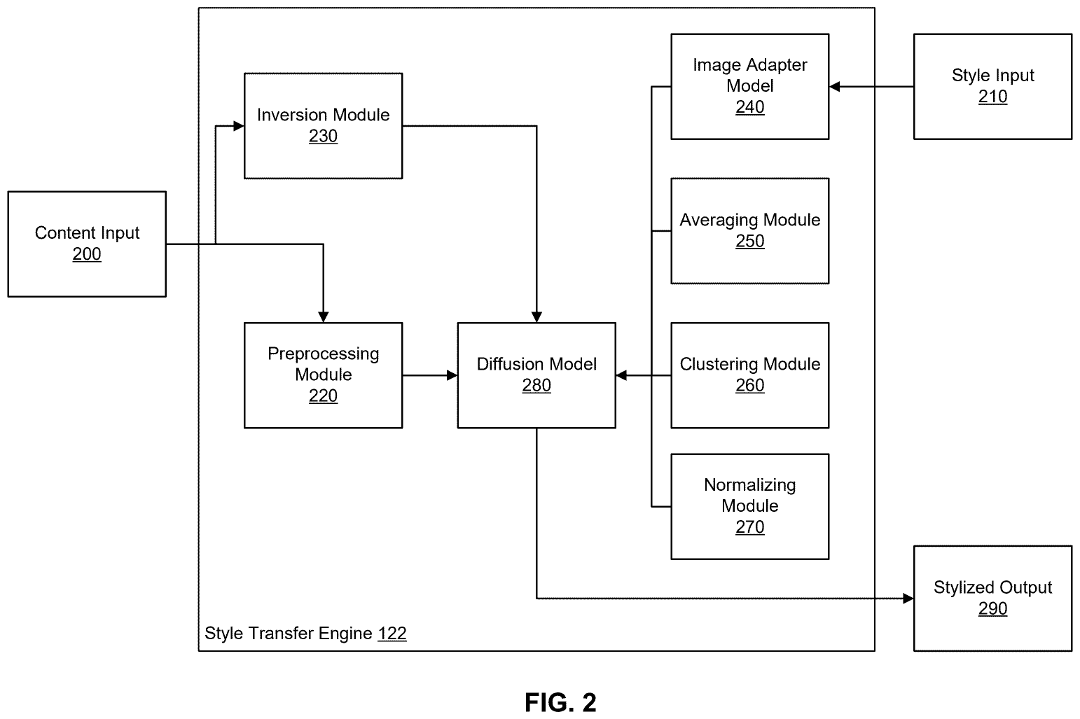

FIG. 2 is a more detailed illustration of style transfer engine 122 of FIG. 1, according to some embodiments. Style transfer engine 122 generates stylized output 290 based at least on content elements included in content input 200 and style elements included in style input 210. Style transfer engine 122 includes, without limitation, inversion module 230, preprocessing module 220, image adapter model 240, averaging module 250, clustering module 260, normalizing module 270, and diffusion model 280.

In various embodiments, content input 200 may include an image depicting one or more objects, such as animals, people, buildings, or vehicles. Content input 200 may also include a depiction of an image foreground and/or an image background, such as a field of grass or a sky scene. Content input 200 may include multiple content elements, where a content element defines a shape, boundary, or other structure of a depicted object, foreground, or background. Content elements may include, but are not limited to, features such as objects, lines, edges, outlines, or surfaces. Style transfer engine 122 may transmit content input 200 to preprocessing module 220 and inversion module 230.

In various embodiments, style input 210 may include one or more style images, where each style image includes one or more style elements. Style elements may include, but are not limited to, colors, textures, patterns, artistic styles or lighting characteristics. In an instance where style input 210 includes multiple style images, the multiple style images may share one or more common style elements. For example, style input 210 may include multiple style images, where each style image includes a depiction of a watercolor painting. Multiple style images may also share an artistic style, such as impressionism or cubism. Multiple style images may share a common color palette, common textures, and/or common lighting characteristics. Style transfer engine 122 may transmit style input 210 to image adapter model 240.

In various embodiments, stylized output 290 includes an image exhibiting one or more content elements included in content input 200 and one or more style elements included in style input 210. For example, given content input 200 that includes an image of a building, and style input 210 that includes multiple images of oil paintings, stylized output 290 may include a depiction of the building executed in the style of an oil painting.

In various embodiments, diffusion model 280 includes a trained generative machine learning model, and generates stylized output 290 based on content input 200 and style input 210. Diffusion model 280 may receive a latent representation x of a content image I_{c} included in content input 200, augmented with randomized noise. Diffusion model 280 may iteratively denoise the noisy latent representation of the content image, subject to various guidance and/or control inputs based on content input 200 and style input 210. These guidance and/or control inputs are described below in the descriptions of various components included in style transfer engine 122.

In various embodiments, diffusion model 280 includes a U-Net architecture. The U-Net architecture includes a convolution neural network having multiple convolutional layers, including self-attention layers and cross-attention layers. Style transfer engine 122 guides the operation of diffusion model 280 via style injection at the self-attention and cross-attention layers, based on style images included in style input 210. Style transfer engine 122 also performs feature normalization within diffusion model 280 based on style input 210. Style transfer engine 122 further controls the operation of diffusion model 280 based on one or more features extracted from content input 200, such as depth maps or object outlines.

Inversion module 230 may convert a content image I_{c} included in content input 200 into a latent representation x of the content image. In various embodiments, inversion module 230 may include a Denoising Diffusion Implicit Model (DDIM) technique including a variational auto-encoder that inverts the content image I_{c} into its latent representation x. Inversion module 230 may also add per-pixel randomized noise to the latent representation x. Style transfer engine 122 transmits the latent representation and randomized noise to diffusion model 280.

In various embodiments, preprocessing module 220 may extract one or more features from a content image I_{c} included in content input 200. These features, such as line art representations and/or depth maps, are applied to diffusion model 280 as extra conditions, and provide additional control during image generation. In various embodiments, the extracted features are applied to diffusion model 280 via one or more neural network architectures, such as the ControlNets neural network architecture.

In various embodiments, preprocessing module 220 may perform edge detection on content image I_{c} and generate one or more line art representations associated with content image I_{c}. For example, preprocessing module 220 may identify the boundary of an object depicted in content image I_{c}, and generate an outline of the depicted object. Preprocessing module 220 may also perform a depth analysis technique on content image I_{c}, and generate a two-dimensional (2D) depth map associated with content image I_{c}. The depth map may include pixel-wise indications of the relative or absolute depths of various locations within content image I_{c}. For example, pixels associated with an object located in the foreground of content image I_{c} may have smaller associated depth map values than pixels associated with objects located in the midground or background of content image I_{c}. While edge detection and depth analysis are provided as example techniques performed by preprocessing module 220, these examples are not intended to be limiting. Additionally or alternatively, preprocessing module 220 may extract other features from content image I_{c} based on different characteristics of content image I_{c}, such as color, luminance, and/or reflectivity. In various embodiments, preprocessing module 220 may determine a pose associated with one or more human and/or animal figures depicted in content image I_{c}, and may extract features describing the determined pose. Style transfer engine 122 transmits the extracted features to diffusion model 280.

In various embodiments, image adapter model 240 trains a projection network [symbol] , based on a set of style images

$$\{ {I}_{1}^{s} , … , {I}_{n}^{s} \}$$

included in style input 210. For each style image included in the set of style images, image adapter model 240 processes the style image using a pre-trained image-to-text model, such as the Contrastive Language-Image Pretraining (CLIP) model, to generate a textual mapping associated with the style image. Based on the textual mapping, the projection network [symbol] included in image adapter model 240 generates a sequence of four tokens having the same dimensionality as the textual mapping. Style transfer engine 122 may train the projection network [symbol] for a predetermined number of steps, e.g., 100 steps, while minimizing the training loss [symbol] :

$${ℒ}_{𝒜} = {𝔼}_{{I}_{i}^{s} ∈ 𝒮} {‖ ϵ - {ϵ}_{θ}^{A} ( {x}_{t} , {τ}_{θ} ( y ) , t , {x}_{i}^{s} ) ‖}^{2} , \qquad Equation ( 1 )$$

where

$${ϵ}_{θ}^{A}$$

represents the results obtained from the operation of both denoiser ∈_{θ} included in diffusion model 280 and the image projection network [symbol] . The term xₜ denotes the latent representation of style image

$${I}_{i}^{s}$$

at time step t, and τ_{θ} represents the transformation of the image-to-text model output y into embedding tokens by projection network [symbol] . θ represents the adjustable parameters of image adapter model 240.

Style transfer engine 122 may train image adaptor model 240 to reconstruct the style images (

$${I}_{i}^{s}$$

∈ [symbol] ) from the token sequences generated by projection network [symbol] , while updating only the adjustable parameters θ associated with projection network [symbol] of image adapter model 240. After training image adapter model 240, style transfer engine 122 transmits the generated embedding token sequences associated with each of the style images

$${I}_{i}^{s}$$

to averaging module 250.

In various embodiments, averaging module 250 generates an average embedding ϕ^{s} based on interpolation of the embedding token sequences generated for the style images (

$${I}_{i}^{s}$$

∈ [symbol] ) by projection network [symbol] of image adapter model 240. The multiple style images

$${l}_{i}^{s}$$

may include differing content elements, but share one or more style elements. By averaging the embedding token sequences, averaging module 250 emphasizes the shared style elements, while minimizing the differing content elements:

$${ϕ}^{s} = {\sum }_{{I}_{i}^{s} ∈ 𝒮} \frac{1}{n} 𝒜 ( {I}_{i}^{s} ) \qquad Equation ( 2 )$$

By minimizing the different content elements included in multiple style images while emphasizing the shared style elements, style transfer engine 122 may avoid entanglement between the content elements included in the style images and the style elements included in the style images. In one example of entanglement, content elements included in a style image, such as lines and surfaces representing a building, may inadvertently appear in the stylized output, even though the stylized output should ideally only contain content elements inherited from the content image included in content input 200.

Averaging module 250 applies the average embedding ϕ^{s} to one or more cross-attention layers included in diffusion model 280 to guide the operation of diffusion model 280. Averaging module 250 also transmits average embedding ϕ^{s} to normalizing module 270.

In various embodiments, normalizing module 270 generates an average style image Ī^{s} based on the average embedding ϕ^{s} received from averaging module 250. Style transfer engine 122 may transmit average embedding ϕ^{s} to diffusion model 280, and execute diffusion model 280 with no other guidance to generate the average style image Ī^{s}. The content elements included in average style image Ī^{s} may be random, and may not reflect content elements included in any of the style images Iᵢ^{s}. The style elements included in average style image Ī^{s} are based on the average embedding ϕ^{s}, and represent an average of the style elements included in style images

$${I}_{i}^{s} .$$

In various embodiments, normalizing module 270 may also calculate normalization and alignment statistics based on one or more attention values calculated when generating average style image Ī^{s}. During the execution of diffusion model 280, normalizing module 270 calculates average query \hat{Q}_{c} and average key \hat{K}_{c}:

$${\hat{Q}}_{c} = AdaIN ( {Q}_{c} , {\overline{Q}}^{s} ) , {\hat{K}}_{c} = AdaIN ( {K}_{c} , {\overline{K}}^{s} ) \qquad Equation ( 3 )$$

Terms Q̅^{s} and K̅^{s} represent the queries and keys obtained when generating the average style image Ī^{s}, respectively. Q_{c} and K_{c} represent query values and key values generated by diffusion model 280 during a current denoising step and associated with content image I_{c}. The AdaIN function refers to Adaptive Instance Normalization, where normalizing module 270 aligns the mean and variance of keys associated with content image I_{c} with keys associated with average style image Ī^{s}. Likewise, normalizing module 270 aligns the mean and variance of queries associated with content image I_{c} with queries associated with average style image Ī^{s}. Normalizing module 270 transmits the calculated normalization and alignment statistics to diffusion model 280 to guide the operation of diffusion model 280.

In various embodiments, clustering module 260 generates self-attention map keys and values associated with each input style image

$${I}_{i}^{s}$$

at each time step of the execution of diffusion model 280 and for each self-attention layer included in diffusion model 280. Clustering module 260 performs k-means clustering of the generated self-attention map values, and calculates a centroid associated with each of the k clusters. For each calculated centroid, clustering module 260 selects the self-attention map value closest to the centroid. Because keys and values are paired, clustering module 260 may retrieve the corresponding key associated with each selected self-attention map value.

The selected self-attention map values and corresponding keys associated with the k clusters form representative attention map keys and values (K_{*}^{s}, V_{*}^{s}). By selecting only the k key-value pairs having values closest to the values of the k centroids, clustering module 260 may generate self-attention maps that are representative of multiple style images, while requiring far less memory space than full attention maps associated with all style images included in style input 210. Clustering module 260 transmits the representative attention map keys and values (K_{*}^{s}, V_{*}^{s}) to one or more self-attention layers included in diffusion model 280 to guide the operation of diffusion model 280:

$$Attention ( {\hat{Q}}_{c} , [ \begin{matrix}{\hat{K}}_{c} & {K}_{⋆}^{s}\end{matrix} ] , [ \begin{matrix}{V}_{c} & {V}_{⋆}^{s}\end{matrix} ] ) \qquad Equation ( 4 )$$

In Equation (4), \hat{Q}_{c} and \hat{K}_{c} are obtained from Equation (3) above, while V_{c} represents a self-attention value associated with the noisy latent representation of the content image processed by diffusion model 280 at the current denoising step.

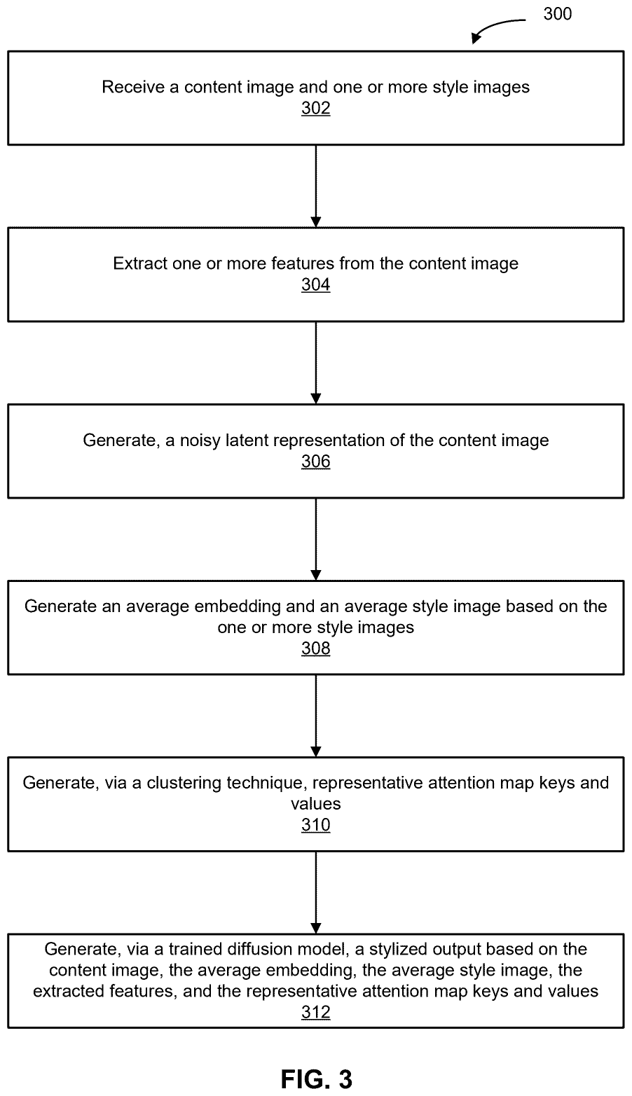

FIG. 3 is a flow diagram of method steps for performing style transfer, according to some embodiments. Although the method steps are described in conjunction with the systems of FIGS. 1-2, persons skilled in the art will understand that any system configured to perform the method steps in any order falls within the scope of the present disclosure.

As shown, in step 302 of method 300, style transfer engine 122 receives a content image included in content input 200 and one or more style images included in style input 210. The content image may include one or more content elements, such as objects, lines, edges, outlines, or surfaces. For example, the content image may include a depiction of a building. Each of the one or more style images may include style elements such as colors, textures, patterns, artistic styles, or lighting characteristics. For example, each of the one or more style images may depict a watercolor painting.

In step 304, preprocessing module 220 of style transfer engine 122 may extract one or more features from the content image. For example, preprocessing module 220 may generate line art representing outlines of one or more objects included in the content image. Preprocessing module 220 may also generate a depth map associated with the content image, where pixels representing an object in the foreground of the content image may include associated depth values that are smaller than depth values associated with pixels representing a background of the content image. Preprocessing module 220 may also generate a representation of a pose exhibited by a human or animal depicted in the content image. Style transfer engine 122 transmits the one or more extracted features to diffusion model 280 to guide the operation of diffusion model 280.

In step 306, inversion module 230 of style transfer engine 122 generates a noisy latent representation of the content image. For example, inversion module 230 may employ a Denoising Diffusion Implicit Model (DDIM) technique, including a variational auto-encoder that inverts the content image into its latent representation. Inversion module 230 may also add per-pixel randomized noise to the latent representation. Style transfer engine 122 transmits the latent representation and randomized noise as a content input to diffusion model 280.

In step 308, image adapter model 240 of style transfer engine 122 trains a projection network to generate embeddings associated with each of the one or more style images included in style input 210. For each style image, image adapter model 240 generates a textual mapping associated with the style image via a pre-trained machine learning model, such as the Contrastive Language-Image Pretraining (CLIP) model. Based on the textual mapping, the projection network included in image adapter model 240 generates an embedding including a sequence of four tokens having the same dimensionality as the textual mapping.

Averaging module 250 generates an average embedding based on interpolation of the embedding token sequences generated for the one or more style images by the projection network of image adapter model 240. The multiple style images may include differing content elements, but share one or more style elements. By interpolating the embedding token sequences to generate an average embedding, averaging module 250 emphasizes the shared style elements, while minimizing the differing content elements. Averaging module 250 transmits the average embedding to normalizing module 270.

Normalizing module 270 generates an average style image based on the average embedding received from averaging module 250. Style transfer engine 122 may transmit average embedding to diffusion model 280, and execute diffusion model 280 with no other guidance to generate the average style image. The content elements included in the average style image may be random, and may not reflect content elements included in any of the style images. The style elements included in the average style image are based on the average embedding, and represent an average of the style elements included in the style images.

Style transfer engine 122 applies the average embedding to one or more cross-attention layers included in diffusion model 280 to guide the operation of diffusion model 280. Style transfer engine 122 applies the average style image to diffusion model 280 to normalize the features generated by diffusion model 280 during iterative denoising steps.

In step 310, clustering module 260 of style transfer engine 122 generates representative attention map keys and values associated with the one or more style images included in style input 210. At each time step during the operation of diffusion model 280, clustering module 260 generates self-attention keys and values for each of the one or more style images. Clustering module 260 performs k-means clustering on the generated values and calculates a centroid value associated with each of the k clusters. For each cluster centroid, clustering module 260 selects the self-attention value that is closest to the cluster centroid and retrieves the corresponding self-attention key. The selected self-attention values and corresponding keys form representative attention maps that represent all of the style images while requiring fewer memory resources compared to full attention maps generated for all style images.

In step 312, diffusion model 280 of style transfer engine 122 generates stylized output 290 based on the content image, the average embedding, the average style image, the features extracted from the content image, and the representative attention map keys and values. Stylized output 290 includes an image exhibiting one or more content elements included in content input 200 and one or more style elements included in style input 210. For example, given content input 200 that includes an image of a building, and style input 210 that includes multiple images of oil paintings, stylized output 290 may include a depiction of the building executed in the style of an oil painting.

Diffusion model 280 of style transfer engine 122 receives as input a noisy latent representation of the content image included in content input 200. Diffusion model 280 may iteratively denoise the noisy latent representation of the content image, subject to various guidance and/or control inputs based on content input 200 and style input 210.

In various embodiments, diffusion model 280 includes a U-Net architecture. The U-Net architecture includes a convolution neural network having multiple convolutional layers, including self-attention layers and cross-attention layers. Style transfer engine 122 guides the operation of diffusion model 280 via style injection at the self-attention and cross-attention layers, based on style images included in style input 210. Style transfer engine 122 also performs feature normalization within diffusion model 280 based on style input 210. Style transfer engine 122 further controls the operation of diffusion model 280 based on one or more features extracted from content input 200, such as depth maps or object outlines.

Style transfer engine 122 modifies the self-attention mechanism included in one or more self-attention layers of diffusion model 280, based on the representative attention map keys and values generated by clustering module 260. Style transfer engine also modifies the cross-attention mechanism included in one or more cross-attention layers of diffusion model 280 based on the average embedding generated by averaging module 250. Style transfer engine 122 transmits the one or more features extracted from the content image by preprocessing module 220 to control the operation of diffusion model 280 via one or more neural network architectures, such as ControlNets. Style transfer engine 122 further normalizes the features generated by diffusion model 280 based on the average style image generated by normalizing module 270.

In sum, the disclosed techniques include a style transfer engine that generates a stylized output image based on a supplied content image and one or more supplied style images. The stylized output image includes content elements inherited from the content image, as well as style elements inherited from the one or more style images. For example, given a content image including a depiction of a person, and multiple style images each depicting a watercolor painting, the style transfer engine may generate a stylized output image that includes the person depicted in the style of a watercolor painting.

In operation, a style transfer engine receives a content image including one or more content elements, such as objects, lines, edges, outlines, or surfaces. The style transfer engine also receives one or more style images that share one or more style elements, such as colors, textures, patterns, artistic styles, or lighting characteristics. The style transfer engine includes a trained diffusion model operable to generate a stylized output image based on the content image and the style images.

The style transfer engine extracts a latent representation of the content image, and adds randomized noise to the latent representation. The style transfer engine transmits the noisy latent representation to the trained diffusion model as input. The style transfer engine also extracts one or more features from the content image, such as a depth map or one or more object outlines. The style transfer engine transmits these extracted features to the trained diffusion model as control inputs to guide the operation of the trained diffusion model.

The style transfer engine extracts latent features from each of the multiple style images, and generates embeddings associated with each of the style images, based on the latent features. The style transfer engine generates an average embedding based on an interpolation of the multiple style image embeddings, and transmits the average embedding to one or more cross-attention layers included in the trained diffusion model, to guide the operation of the trained diffusion model. The style transfer engine also generates an average style image based on the average embedding, and normalizes features generated by the trained diffusion model based on the average style image.

At each time step during the operation of the trained diffusion model, the style transfer engine generates self-attention keys and values associated with each of the multiple style images. The style transfer engine performs k-means clustering on the generated self-attention values, and calculates a centroid associated with each of the k clusters. For each cluster centroid, the style transfer engine selects the self-attention value closest to the centroid value, and retrieves the corresponding self-attention key. The collection of selected self-attention values and associated keys form representative attention map keys and values, and the style transfer engine transmits the representative attention map keys and values to one or more self-attention layers included in the trained diffusion model to guide the operation of the diffusion model.

The trained diffusion model receives the noisy latent representation of the content image and iteratively denoises the latent representation, while being guided by the features extracted from the content image, the average embedding of the style images, the representative attention map keys and values, and the average style image. The output of the trained diffusion model includes an image exhibiting one or more content elements included in the supplied content image and one or more style elements included in the supplied style images.

One technical advantage of the disclosed techniques relative to the prior art is that the disclosed techniques leverage multiple supplied style images to improve visual performance in generating novel images. Specifically, the disclosed techniques may consider a large number of style images by distilling a small representative set of features from multiple style images, reducing computing requirements. The disclosed techniques also avoid content/style entanglement when performing style transfer. These technical advantages provide one or more improvements over prior art approaches.

1. In some embodiments, a computer-implemented method for performing style transfer, the computer-implemented method comprises receiving a content image including one or more content elements, and multiple style images each including one or more style elements, generating an average embedding and an average style image based on the multiple style images, generating, via a clustering technique, a representative set of attention map keys and values associated with the multiple style images, and generating, via a trained machine learning model and based at least on the average embedding, the average style image, and the representative set of attention map keys and values, a stylized output image including at least one of the one or more content elements and at least one of the one or more style elements.

2. The computer-implemented method of clause 1, further comprising extracting one or more features from the content image, wherein the generating the stylized output image is further based at least on the one or more extracted features.

3. The computer-implemented method of clauses 1 or 2, wherein the one or more extracted features include one or more of an object outline associated with an object included in the content image, a depth map associated with the content image, or a pose associated with a human or animal figure included in the content image.

4. The computer-implemented method of any of clauses 1-3, wherein the average embedding is transmitted to at least one cross-attention layer included in the trained machine learning model.

5. The computer-implemented method of any of clauses 1-4, wherein the representative set of attention map keys is transmitted to at least one self-attention layer included in the trained machine learning model.

6. The computer-implemented method of any of clauses 1-5, further comprising normalizing, based on at least the average style image, one or more key values and one or more query values generated by the trained machine learning model.

7. The computer-implemented method of any of clauses 1-6, wherein the clustering technique includes a k-means clustering technique and wherein generating the representative set of attention map keys and values further comprises assigning each of multiple attention map values to one of k clusters, calculating a centroid value associated with each cluster, identifying a closest attention map value associated with each centroid, and retrieving a corresponding attention map key associated with each of the closest attention map values.

8. The computer-implemented method of any of clauses 1-7, wherein generating the average embedding further comprises generating, via a projection network machine learning model, embeddings associated with each of multiple style images, and performing an interpolation technique on the multiple embeddings to generate the average embedding.

9. The computer-implemented method of any of clauses 1-8, wherein generating the average style image further comprises generating a noisy latent representation based on the average embedding and iteratively denoising the noisy latent representation via a trained denoising model to generate the average style image.

10. In some embodiments, one or more non-transitory computer-readable media store instructions that, when executed by one or more processors, cause the one or more processors to perform the steps of receiving a content image including one or more content elements, and multiple style images each including one or more style elements, generating an average embedding and an average style image based on the multiple style images, generating, via a clustering technique, a representative set of attention map keys and values associated with the multiple style images, and generating, via a trained machine learning model and based at least on the average embedding, the average style image, and the representative set of attention map keys and values, a stylized output image including at least one of the one or more content elements and at least one of the one or more style elements.

11. The one or more non-transitory computer-readable media of clause 10, further comprising extracting one or more features from the content image, wherein the generating the stylized output image is further based at least on the one or more extracted features.

12. The one or more non-transitory computer-readable media of clauses 10 or 11, wherein the one or more extracted features include one or more of an object outline associated with an object included in the content image, a depth map associated with the content image, or a pose associated with a human or animal figure included in the content image.

13. The one or more non-transitory computer-readable media of any of clauses 10-12, wherein the average embedding is transmitted to at least one cross-attention layer included in the trained machine learning model.

14. The one or more non-transitory computer-readable media of any of clauses 10-13, wherein the representative set of attention map keys is transmitted to at least one self-attention layer included in the trained machine learning model.

15. The one or more non-transitory computer-readable media of any of clauses 10-14, further comprising normalizing, based on at least the average style image, one or more key values and one or more query values generated by the trained machine learning model.

16. The one or more non-transitory computer-readable media of any of clauses 10-15, wherein the clustering technique includes a k-means clustering technique and wherein generating the representative set of attention map keys and values further comprises assigning each of multiple attention map values to one of k clusters, calculating a centroid value associated with each cluster, identifying a closest attention map value associated with each centroid, and retrieving a corresponding attention map key associated with each of the closest attention map values.

17. The one or more non-transitory computer-readable media of any of clauses 10-16, wherein generating the average embedding further comprises generating, via a projection network machine learning model, embeddings associated with each of multiple style images, and performing an interpolation technique on the multiple embeddings to generate the average embedding.

18. The one or more non-transitory computer-readable media of any of clauses 10-17, wherein generating the average style image further comprises generating a noisy latent representation based on the average embedding and iteratively denoising the noisy latent representation via a trained denoising model to generate the average style image.

19. In some embodiments, a system comprises one or more memories storing instructions, and one or more processors for executing the instructions to receive a content image including one or more content elements, and multiple style images each including one or more style elements, generate an average embedding and an average style image based on the multiple style images, generate, via a clustering technique, a representative set of attention map keys and values associated with the multiple style images, and generate, via a trained machine learning model and based at least on the average embedding, the average style image, and the representative set of attention map keys and values, a stylized output image including at least one of the one or more content elements and at least one of the one or more style elements.

20. The system of clause 19, wherein the clustering technique includes a k-means clustering technique and wherein generating the representative set of attention map keys and values further comprises assigning each of multiple attention map values to one of k clusters, calculating a centroid value associated with each cluster, identifying a closest attention map value associated with each centroid, and retrieving a corresponding attention map key associated with each of the closest attention map values.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing style transfer, the computer-implemented method comprising:
receiving a content image including one or more content elements, and multiple style images each including one or more style elements;
generating an average embedding and an average style image based on the multiple style images;
generating, via a clustering technique, a representative set of attention map keys and values associated with the multiple style images; and
generating, via a trained machine learning model and based at least on the average embedding, the average style image, and the representative set of attention map keys and values, a stylized output image including at least one of the one or more content elements and at least one of the one or more style elements.

2. The computer-implemented method of claim 1, further comprising extracting one or more features from the content image, wherein the generating the stylized output image is further based at least on the one or more extracted features.

3. The computer-implemented method of claim 2, wherein the one or more extracted features include one or more of an object outline associated with an object included in the content image, a depth map associated with the content image, or a pose associated with a human or animal figure included in the content image.

4. The computer-implemented method of claim 1, wherein the average embedding is transmitted to at least one cross-attention layer included in the trained machine learning model.

5. The computer-implemented method of claim 1, wherein the representative set of attention map keys is transmitted to at least one self-attention layer included in the trained machine learning model.

6. The computer-implemented method of claim 1, further comprising normalizing, based on at least the average style image, one or more key values and one or more query values generated by the trained machine learning model.

7. The computer-implemented method of claim 1, wherein the clustering technique includes a k-means clustering technique and wherein generating the representative set of attention map keys and values further comprises assigning each of multiple attention map values to one of k clusters, calculating a centroid value associated with each cluster, identifying a closest attention map value associated with each centroid, and retrieving a corresponding attention map key associated with each of the closest attention map values.

8. The computer-implemented method of claim 1, wherein generating the average embedding further comprises generating, via a projection network machine learning model, embeddings associated with each of multiple style images, and performing an interpolation technique on the multiple embeddings to generate the average embedding.

9. The computer-implemented method of claim 1, wherein generating the average style image further comprises generating a noisy latent representation based on the average embedding and iteratively denoising the noisy latent representation via a trained denoising model to generate the average style image.

10. One or more non-transitory computer-readable media storing instructions that, when executed by one or more processors, cause the one or more processors to perform the steps of:
receiving a content image including one or more content elements, and multiple style images each including one or more style elements;
generating an average embedding and an average style image based on the multiple style images;
generating, via a clustering technique, a representative set of attention map keys and values associated with the multiple style images; and
generating, via a trained machine learning model and based at least on the average embedding, the average style image, and the representative set of attention map keys and values, a stylized output image including at least one of the one or more content elements and at least one of the one or more style elements.

11. The one or more non-transitory computer-readable media of claim 10, further comprising extracting one or more features from the content image, wherein the generating the stylized output image is further based at least on the one or more extracted features.

12. The one or more non-transitory computer-readable media of claim 11, wherein the one or more extracted features include one or more of an object outline associated with an object included in the content image, a depth map associated with the content image, or a pose associated with a human or animal figure included in the content image.

13. The one or more non-transitory computer-readable media of claim 10, wherein the average embedding is transmitted to at least one cross-attention layer included in the trained machine learning model.

14. The one or more non-transitory computer-readable media of claim 10, wherein the representative set of attention map keys is transmitted to at least one self-attention layer included in the trained machine learning model.

15. The one or more non-transitory computer-readable media of claim 10, further comprising normalizing, based on at least the average style image, one or more key values and one or more query values generated by the trained machine learning model.

16. The one or more non-transitory computer-readable media of claim 10, wherein the clustering technique includes a k-means clustering technique and wherein generating the representative set of attention map keys and values further comprises assigning each of multiple attention map values to one of k clusters, calculating a centroid value associated with each cluster, identifying a closest attention map value associated with each centroid, and retrieving a corresponding attention map key associated with each of the closest attention map values.

17. The one or more non-transitory computer-readable media of claim 10, wherein generating the average embedding further comprises generating, via a projection network machine learning model, embeddings associated with each of multiple style images, and performing an interpolation technique on the multiple embeddings to generate the average embedding.

18. The one or more non-transitory computer-readable media of claim 10, wherein generating the average style image further comprises generating a noisy latent representation based on the average embedding and iteratively denoising the noisy latent representation via a trained denoising model to generate the average style image.

19. A system comprising:
one or more memories storing instructions; and
one or more processors for executing the instructions to:
receive a content image including one or more content elements, and multiple style images each including one or more style elements;
generate an average embedding and an average style image based on the multiple style images;
generate, via a clustering technique, a representative set of attention map keys and values associated with the multiple style images; and
generate, via a trained machine learning model and based at least on the average embedding, the average style image, and the representative set of attention map keys and values, a stylized output image including at least one of the one or more content elements and at least one of the one or more style elements.

20. The system of claim 19, wherein the clustering technique includes a k-means clustering technique and wherein generating the representative set of attention map keys and values further comprises assigning each of multiple attention map values to one of k clusters, calculating a centroid value associated with each cluster, identifying a closest attention map value associated with each centroid, and retrieving a corresponding attention map key associated with each of the closest attention map values.
